(19) United States
(12) Patent Application Publication
(10) Pub. No.: US 2012/0105489 A1
(43) Pub. Date: May 3, 2012

(54) Method and Apparatus for Organizing and Delivering Digital Media Content and Interactive Elements

(75) Inventors: Marshall McLaury Monroe, Corrales, NM (US); William Wesley Monroe, Austin, TX (US); Vineet Shriniwas Joshi, Aurora, CO (US); Atul Madhukar Barve, Coppell, TX (US)

(73) Assignee: Marshall Monroe, Albuquerque, NM (US)

(21) Appl. No.: 13/284,472

(22) Filed: Oct. 28, 2011

Related U.S. Application Data
(60) Provisional application No. 61/407,646, filed on Oct. 28, 2010.
(60) Provisional application No. 61/443,916, filed on Feb. 17, 2011.

(51) Int. Cl. G09G 5/00

(52) U.S. Cl. 345/684

(57) ABSTRACT

A method of displaying information on a display (and concomitant non-transitory medium comprising computer software) comprising displaying a cascading variant picker array and simultaneously displaying a gallery of images associated with the information content of the array. Also a method of displaying information on a display (and concomitant non-transitory medium comprising computer software) comprising displaying a background and simultaneously superimposed on the background displaying a vertically scrollable arrangement.

### CROSS-REFERENCE TO RELATED APPLICATIONS

This application claims priority to and the benefit of the filing of U.S. Provisional Patent Application Ser. No. 61/407,646, entitled “Systems, Methods and Media for Accessing Information”, filed on Oct. 28, 2010, and of U.S. Provisional Patent Application Ser. No. 61/443,916, entitled “Apparatus for Organizing and Delivering Digital Media Content and Interactive Elements”, filed on Feb. 17, 2011, and the specifications thereof are incorporated herein by reference.

### STATEMENT REGARDING FEDERALLY SPONSORED RESEARCH OR DEVELOPMENT

Not Applicable.

### INCORPORATION BY REFERENCE OF MATERIAL SUBMITTED ON A COMPACT DISC

Not Applicable.

### COPYRIGHTED MATERIAL

Not Applicable.

### BACKGROUND OF THE INVENTION

1. Field of the Invention (Technical Field)

The present invention relates to methods and apparatuses for organizing and delivering digital media content and interactive elements.

2. Description of Related Art

This invention relates to a structured format for presenting and delivering hybrid media content items to consumers on mobile smart phones, tablets, and even on generic PC desktops. Essentially, it is a method to present multiple media formats inside a single app, and via a cloud data architecture. The challenge to be solved has been that for many years, content has been sold and delivered to consumers based on the single-media format of the item. For example, movies have been sold alongside other movies, in stores like Walmart® and Blockbuster®. Music has been sold in stores like Sound Warehouse® and online at iTunes®. Themed merchandise T-shirts have been sold in racks at myriad department stores. The present invention enables a more intuitive, convenient, aggregation of media types, all organized by content theme or “franchise.” For example, if a customer buys the “Harry Potter” application, which employs the current invention, they can get the movie, the book, some games, the soundtrack, a merchandise store, and other “special feature” content elements, all within the same structured, rights-managed framework. The framework has a “template” that allows users to experience a consistent format that is modular and extensible.

To clarify, the term “franchise” is a term of art in the content industries to refer to the conceptual story or creative identity of a work or intellectual property that is extended across multiple media and merchandise formats. The “franchise” may originate in various forms, including literary, film, music, television, theater, folklore, or general artistic, with examples such as Gone With The Wind, Hawaii Five-O, The Rolling Stones, or Disney's Lion King. In the case of many modern content franchises, they have evolved with instantiations across multiple media forms. For example, the Rolling Stones have hundreds, even thousands of video clips of their work, in addition to the obvious collection of fixed music recordings. They also profit from selling merchandise, for example t-shirts, with their logo(s) on them. In the case of Disney's Lion King, the movie has a sound track that is sold separately, there is a live theater show, and Disney even has built Theme Park areas that allow guests to “step in” to a facsimile of the film experience.

The term presently used, based on this definition, in conjunction with the subject invention, is a “Content Franchise Convergence Format.”

### BRIEF SUMMARY OF THE INVENTION

The present invention is of a method of displaying information on a display (and concomitant non-transitory medium comprising computer software), comprising: displaying a cascading variant picker array; and simultaneously displaying a gallery of images associated with the information content of the array. In the preferred embodiment, a parent-child relationship exists for the elements of the array when moving left to right. The gallery is an element within a vertically scrollable grid of horizontal elements, most preferably wherein two or more of the elements are scrollable horizontally. The array presents categories of items for purchase and the gallery presents images of items found in the corresponding categories, which items can be purchased via the corresponding images. Array displaying comprises displaying a cascading variant picker array proximate a bottom of a display. The picker can be populated via keywords chosen based on search results. Alternative embodiments for the gallery include a grid gallery, a coverflow gallery, a deep zoom gallery, and a list gallery.

The invention is also of a method of displaying information on a display (and concomitant non-transitory medium comprising computer software), comprising: displaying a background; and simultaneously superimposed on the background displaying a vertically scrollable arrangement. In the preferred embodiment, arrangement displaying comprises displaying a vertically scrollable grid of horizontal elements, more preferably wherein two or more of the elements are scrollable horizontally and wherein one of the elements comprises a cascading variant picker array, most preferably wherein a parent-child relationship exists for the elements of the array when moving left to right and wherein one of the elements comprises a gallery of images associated with the information content of the array. All elements of the vertically scrollable arrangement relate to a common topic, more preferably wherein each element relates to a distinct common media format relating to the common topic, and most preferably wherein each element displays items not owned by the user differently from items owned by the user.

Further scope of applicability of the present invention will be set forth in part in the detailed description to follow, taken in conjunction with the accompanying drawings, and in part will become apparent to those skilled in the art upon examination of the following, or may be learned by practice of the invention. The objects and advantages of the invention may be realized and attained by means of the instrumentalities and combinations particularly pointed out in the appended claims.

### BRIEF DESCRIPTION OF THE SEVERAL VIEWS OF THE DRAWINGS

The accompanying drawings, which are incorporated into and form a part of the specification, illustrate one or more embodiments of the present invention and, together with the description, serve to explain the principles of the invention. The drawings are only for the purpose of illustrating one or more preferred embodiments of the invention and are not to be construed as limiting the invention. In the drawings:

FIG. 1a is a display in portrait mode according to the invention;

FIG. 1b is a display in landscape mode according to the invention;

FIG. 2a illustrates the contents of the display;

FIG. 2b provides a full example of the contents of FIG. 2a;

FIG. 3a illustrates an array of pickers according to the invention;

FIG. 3b illustrates an example of such an array as displayed;

FIG. 4 is a schematic diagram of an apparatus according to the invention;

FIG. 5 provides an illustrative data structure useful with the invention;

FIGS. 6 and 7 show an alternative embodiments of the display;

FIG. 8 illustrates a pop up display supplementing the invention;

FIG. 9 illustrates a horizontal gallery useful with the invention;

FIG. 10 illustrates a shopping cart mechanism employed with the invention;

FIG. 11a illustrates use of a dependency spectrum in accordance with the invention;

FIG. 11b illustrates use of a parent/child relationship in accordance with the invention;

FIG. 12 illustrates use of a background plane according to the invention;

FIG. 13a illustrates use of a plurality of horizontal shelves according to the invention;

FIG. 13b shows a data structure useful with the invention;

FIG. 14 illustrates configuration of an apparatus according to the invention;

FIG. 15 illustrates an app according to the invention useful with display of an author's works and other information about the author;

FIG. 16 illustrates an app according to the invention useful in conjunction with a motion picture;

FIG. 17 illustrates an app according to the invention useful in conjunction with a piece of illustrated poetry;

FIG. 18 illustrates a reader module in accordance with the invention; and

FIG. 19 illustrates an embodiment of the display of the invention.

### DETAILED DESCRIPTION OF THE INVENTION

The present invention is of systems, methods, computer software, and tangible media for accessing information. In some embodiments, systems, methods, and media can be used to browse through structured information using a computer or other suitable service that accesses structured data that is either “local” to the machine, on a local area network, on the internet, or on any suitable data storage mechanism. For example, in some embodiments, these systems, methods, and media can be used to perform shopping activities using a touch interface on a mobile device (such as a mobile phone, a tablet computer (e.g., the Apple iPad®), or any other suitable device), using a mouse (or other pointer) interface on a desktop, laptop, or other computer, and/or using any other suitable interface on any other suitable device. As another example, these systems, methods, and media can be used to access pictures, songs, video, documents, applications, and/or any other suitable files or folders on a computer system in some embodiments.

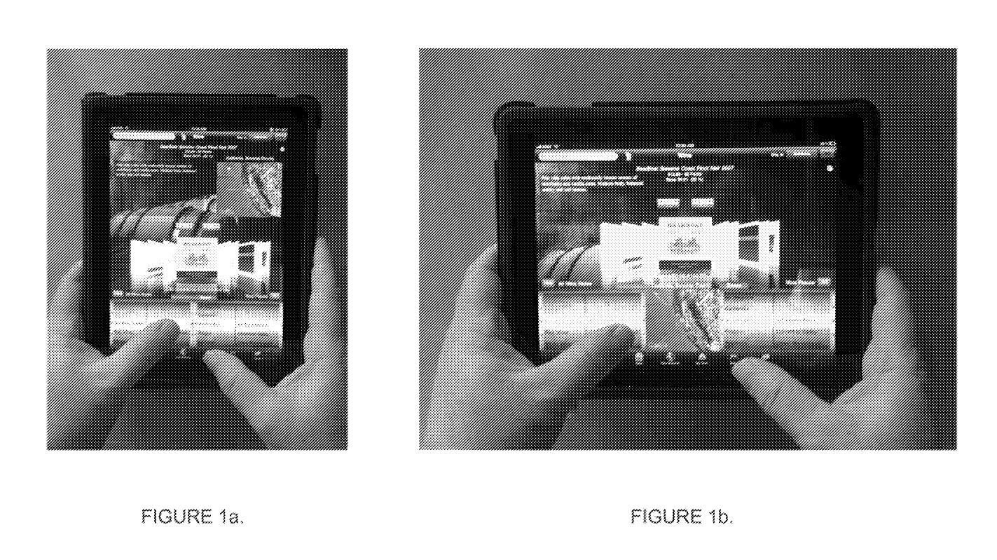

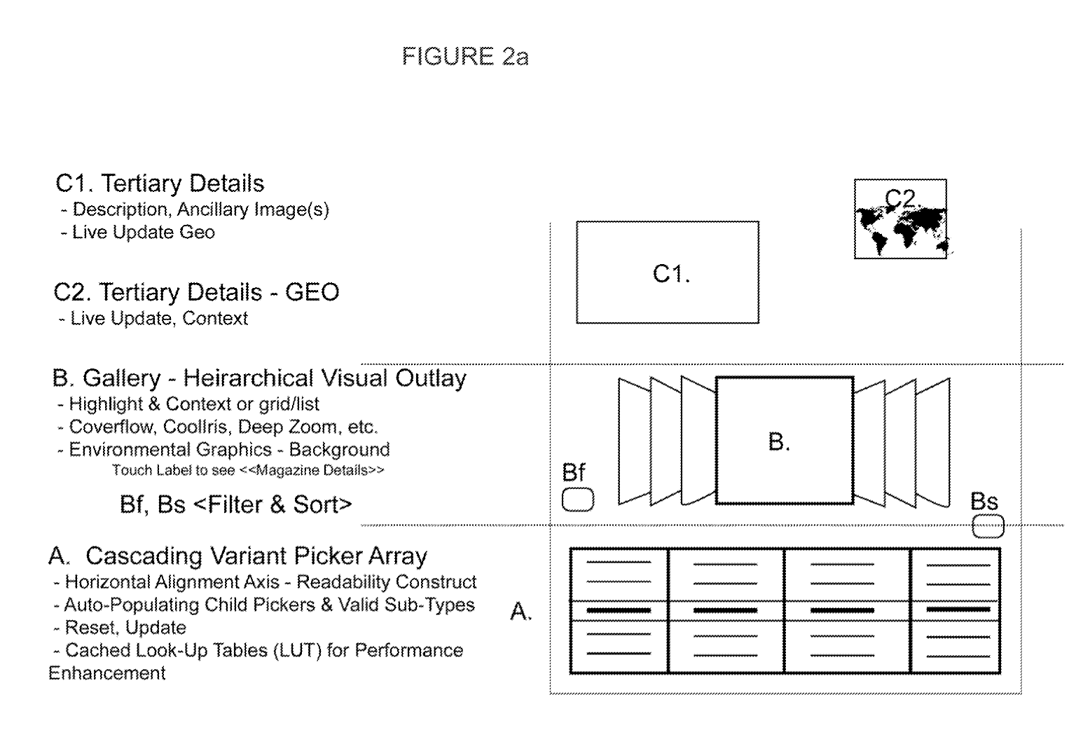

Turning to FIGS. 1a and 1b, an example of a user interface in accordance with some embodiments is shown. As illustrated, this user interface can be operated in a portrait mode (FIG. 1a) or a landscape mode (FIG. 1b) on a touch-screen interface device. Such a device can be held in the hands, or on the lap, and easily operated with a user's fingers and/or thumbs.

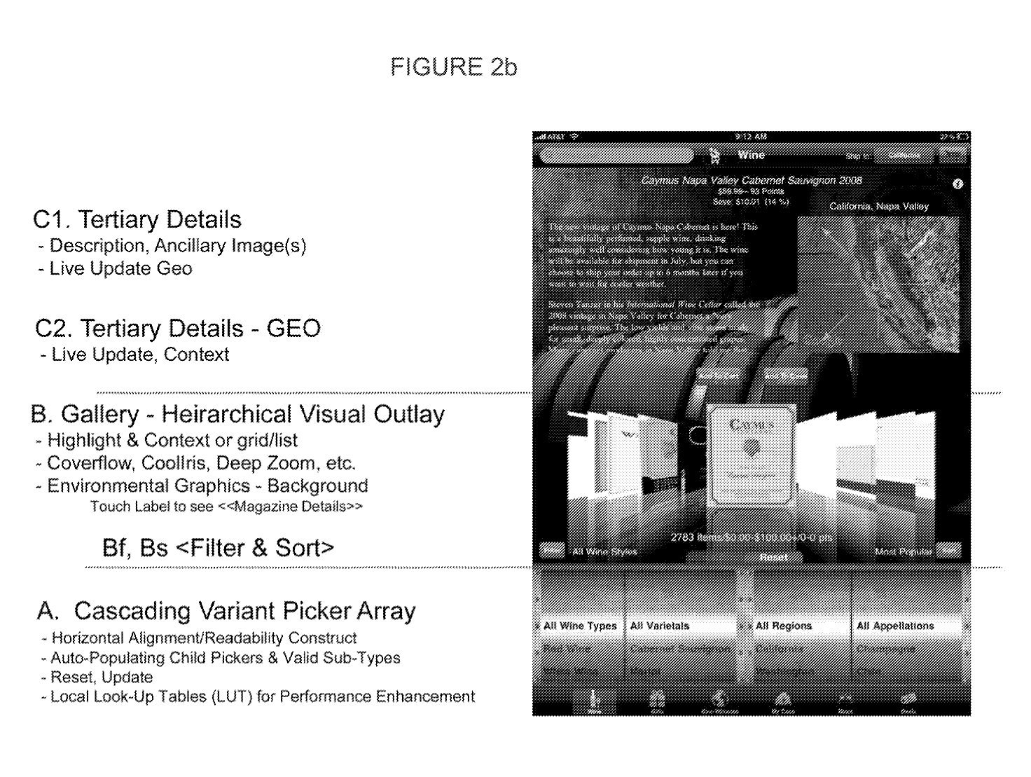

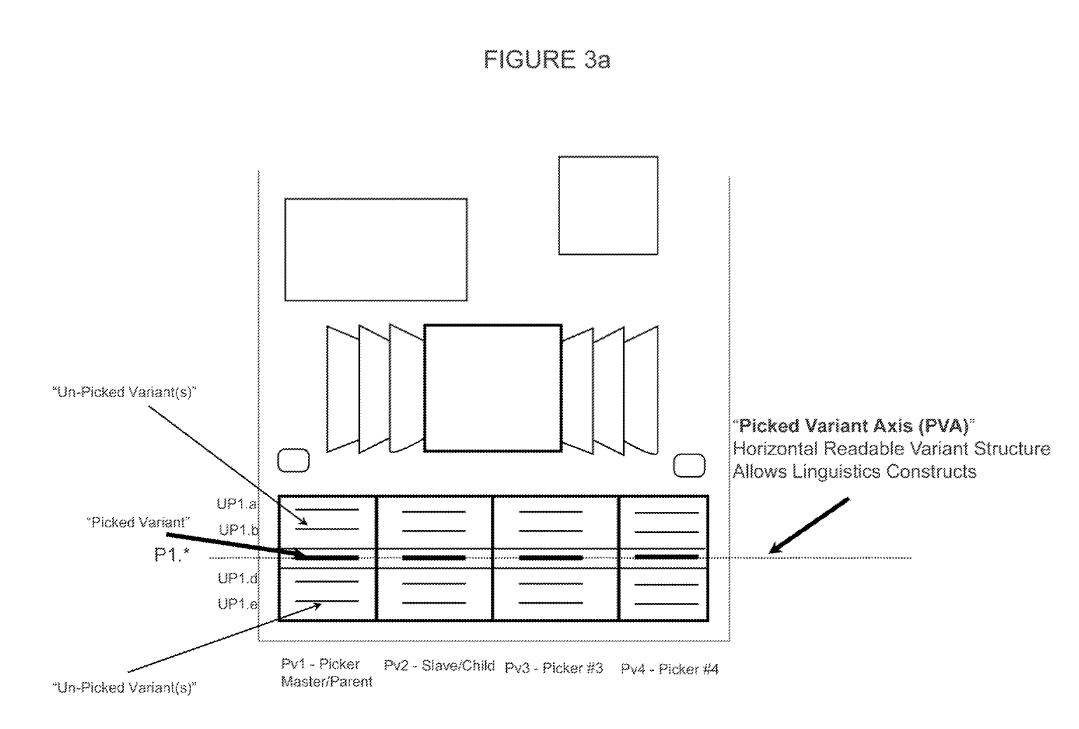

The interface shown in FIGS. 1a and 1b is further described in connection with FIG. 2a. As illustrated, this interface can include an array of “pickers” A, a gallery B, buttons Bf and Bs for controlling the gallery, details C1 and C2, and/or any other suitable components. Detailed examples of these components are further shown in FIG. 2b.

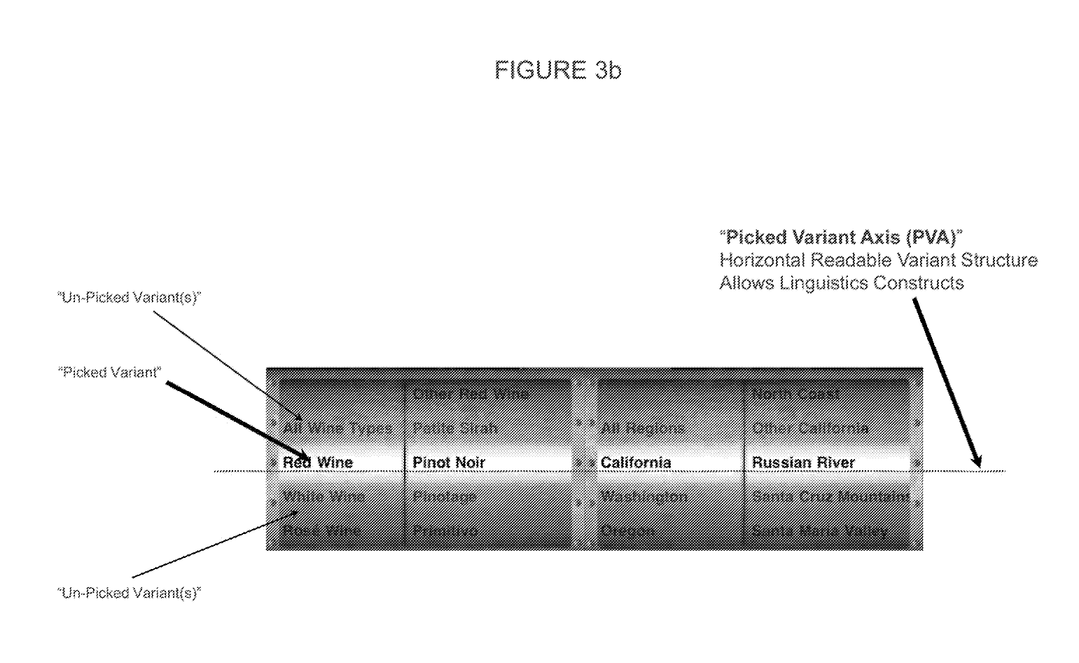

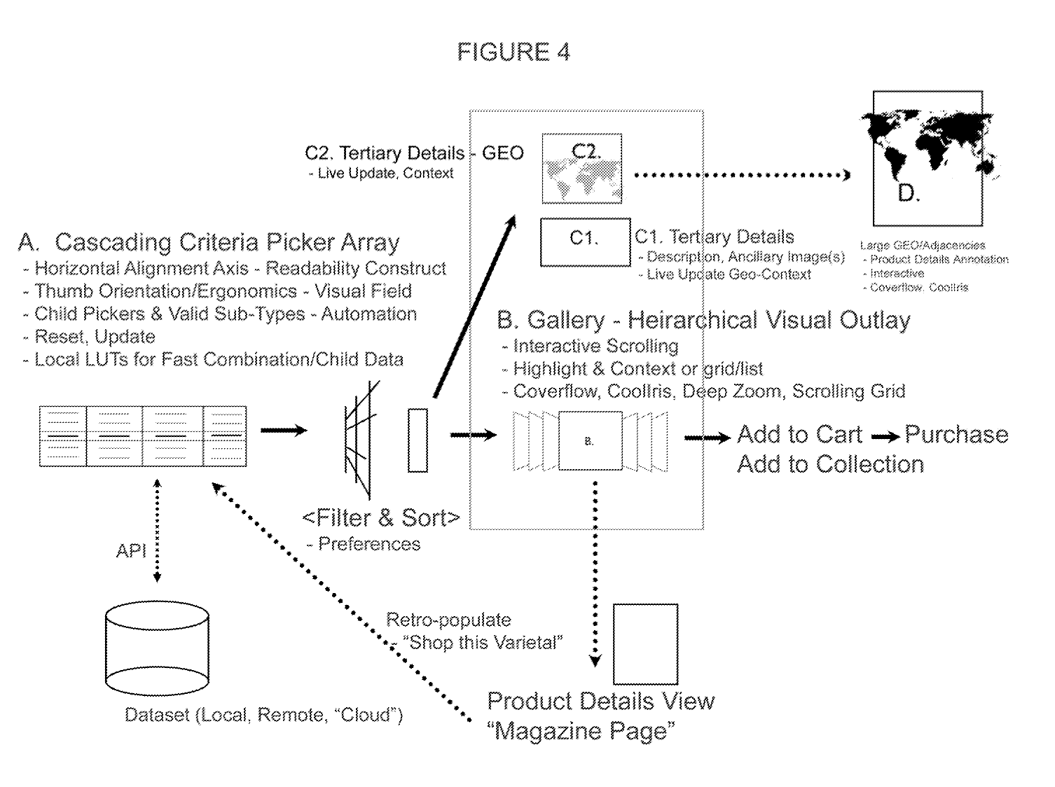

As shown in FIG. 3a, the array of pickers A can include any suitable number (including one) of selection mechanisms for selecting picker variants (e.g., categories and/or subcategories of information). For example, four pickers can be included as illustrated as picker Pv 1, Pv2, Pv3, and Pv4 of FIG. 3a. As illustrated in FIG. 3b, the selection mechanisms can be displayed so as to look like a wheel with labels on its circumference. Turning back to FIG. 3a, this wheel can be rotated by a user swiping the wheel up or down (in the example orientation) to pick (or select) a variant PI* of multiple available variants (UPI.a, UPI.b, UPI.d, and UP1.e). When multiple pickers are provided, a combination of variants (e.g., categories and/or subcategories) can be selected by lining up labels on each “wheel” in a horizontal line (illustrated as a “picked variant axis” in FIG. 3a) across the wheels. While the horizontal line is shown at the mid-level of the wheels, the line could be located at any suitable location (such as the top, the bottom, etc.).

In some embodiments, as illustrated in FIG. 3b, the labels on the wheels can be highlighted to emphasize the currently selected label on each wheel. For example, in some embodiments, a selected label can be presented in highest contrast (black against white), while some not-selected labels can be presented in lower contrast (Dark Brown against Light Brown).

While some labels for available categories and/or subcategories will be shown on each picker wheel, some labels may not be shown. This can represent that the not-shown labels are on portion of the wheel circumference that is not visible to the user.

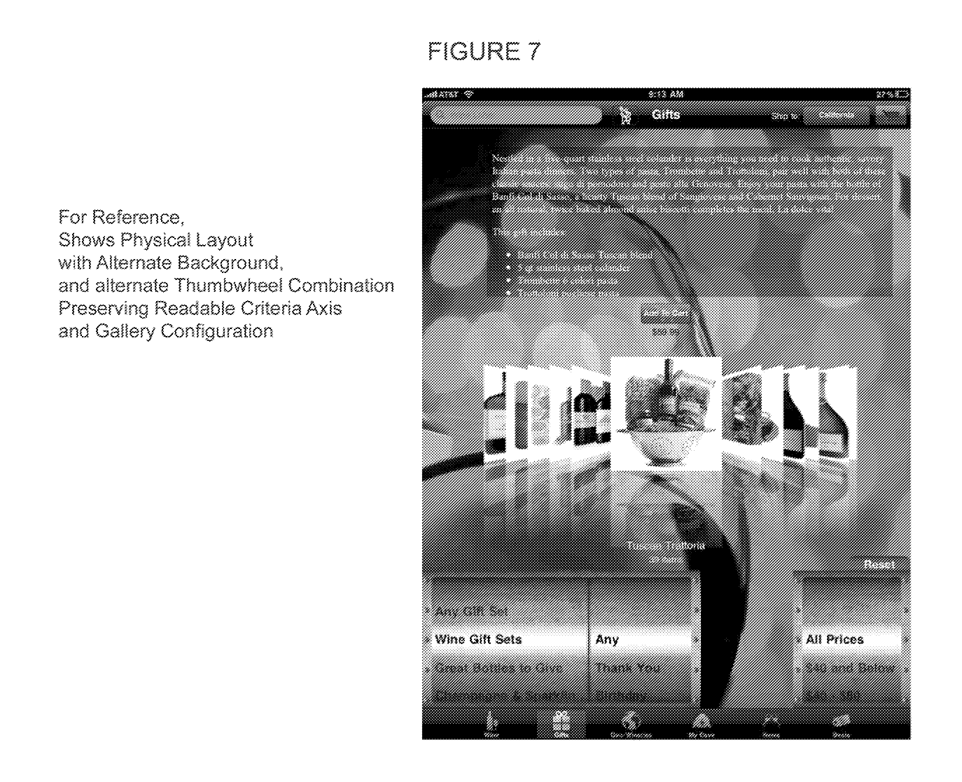

As illustrated in FIG. 1b, in some embodiments, a picker array can be split into two or more portions by some content. For example, as shown in FIG. 1b (and FIG. 6), a map can be presented between the second and third picker wheels. Separating the picker wheels in this way can be performed for any suitable purpose, such as to accommodate ergonomic factors such as the ability of a user” thumbs to reach the wheels when holding a device as shown in FIG. 1b.

When using the pickers, a user can make selections in any suitable order. For example, a user can pick a first label (or variant) in the left-most picker, and then subsequently pick more narrow variants on the second, third, and fourth wheels. In this way, a user can narrow down his/her selection. For example, when selecting a neighborhood, a user could select “United States” on the left-most wheel, then “New York State” on the second wheel, then “New York City” on the third wheel, and then “Downtown” on the right-most wheel.

As another example, when used to select wine (e.g., for a shopping application), a user may at first decide they would like to shop for a red wine and select “red wine” with the left-most picker. This picker may also contain other unpicked variants, such as white wine, rose, saki, sparkling, etc. After the user has selected a variant for the first picker, labels on the second, third, and/or right-most pickers can be populated. In some embodiments, after a variant in a first picker is selected, only the next picker is populated because, without a selection in the second picker, labels for the third and fourth pickers cannot be determined. Next, the user can pick a more specific type of red wine From a list that is auto-populated with red grape types (or “varietals”). As shown in FIG. 3b, the user can select Pinot Noir, for example. The third picker can next be populated with labels for geographic regions corresponding to the combination of the red wine and Pinot Noir varietal selections. As shown in FIG. 3b, the user can select California, for example. Finally, the fourth picker is populated with sub-regions (or “appellations”) corresponding to the California region. As shown in FIG. 3b, the user can select Russian River, for example. Thus, as shown in FIG. 3b, after the user has made his or her selections, the picked variant array can read, from left to right along the picked variant axis:

Red Wine|Pinot Noir|California|Russian River

The picker array can be used in some embodiments to make selections of any suitable things. For example, the picker array can be used to pick clothes, books, music, kitchen wares, furniture, real estate, rental equipment, used cars, new cars, vacation destinations, hotels, etc. in any suitable application, such as a shopping application, a general search application, an inventory system, etc. As another example, the picker array can be used to pick name, nationality, location, affiliations, etc. in an investigative application, a national security application, people tracking, etc. As yet another example, the picker array can be used to pick areas of vocabulary, shape definitions, chemistry molecular structures, economics, architecture, historical people, fine art history, cooking recipes, etc. in an educational application, etc. As yet another example, the picker array can be used to pick plane flights from an airline database, etc. in a travel application, etc. As yet another example, the picker array can be used to pick news categories so that news stories can be selected in a news application, etc.

In some embodiments, the pickers can be located in the lower, outside sections of the screen so as to be accessible to the user's thumbs as shown in FIG. 1b, for example.

In some embodiments, one or more buttons (or other input mechanisms) or display elements (or other output mechanisms) can be present below the pickers.

While the pickers in some embodiments can be represented as wheels (e.g., that look like wine barrels), the pickers can be represented in any suitable manner. For example, the pickers can be any suitable color, can be any suitable type style, can include any suitable number of visible labels, can shown any suitable number of not-picked labels, can include any suitable sound effects (e.g., clicks as the wheels “rotate”), can include any suitable character of graphic overlay “skin”, etc. The pickers can also be in a form other than a rotating list (or wheel). For example, the pickers can be pop-up or pop-over menus, can be blank input boxes (that allow a user to type-in text), etc.

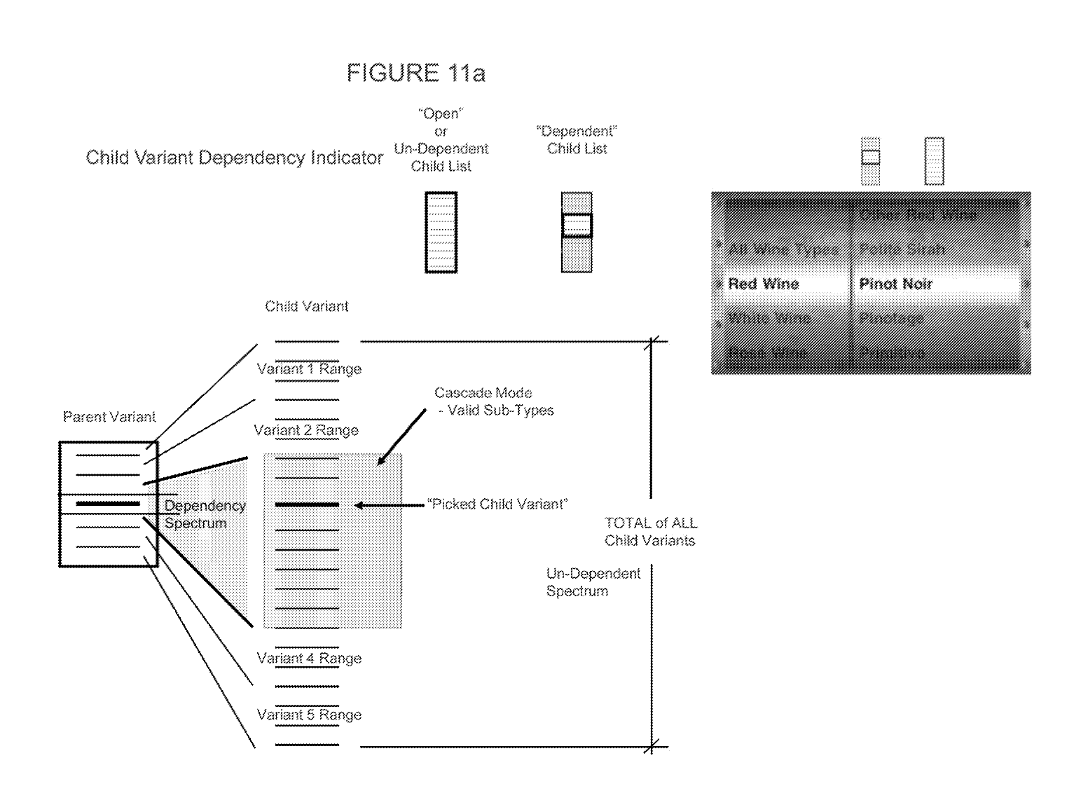

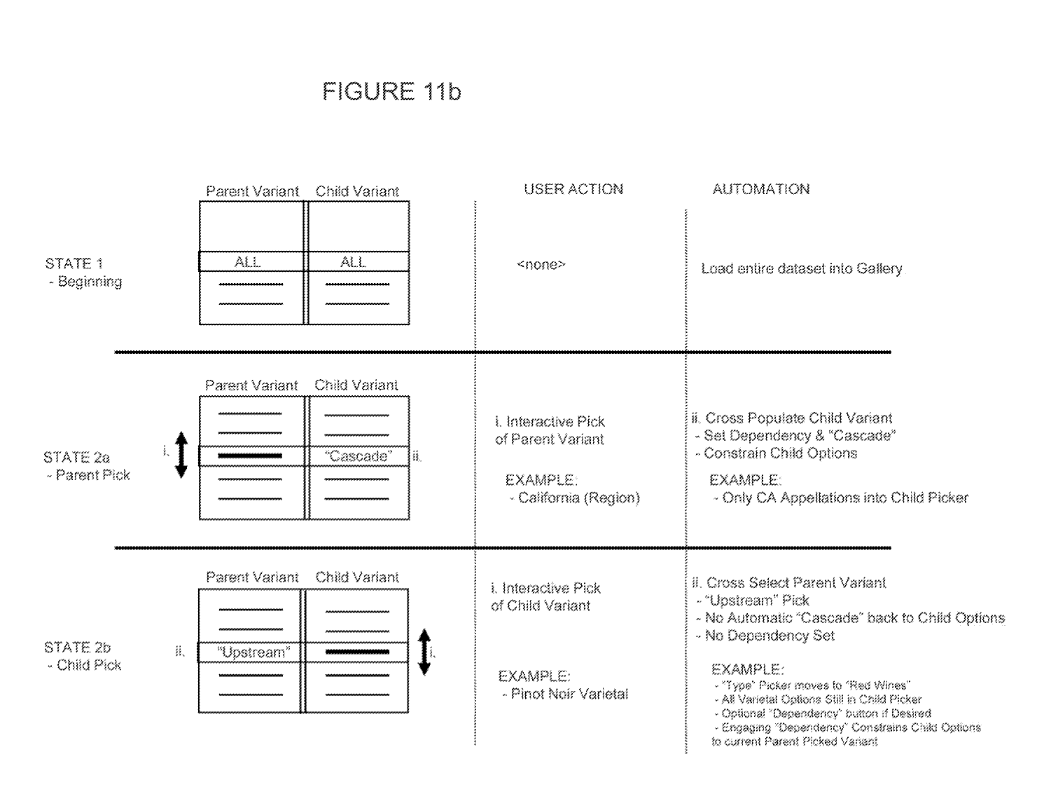

In some embodiments, cross-populating the picker lists can be accomplished based on parent and child picker relationships and user interactions. A parent variant can be defined to mean a variant (such as “wine type”) that has a related “child variant” list. In some embodiments, these parent and child variant pickers can be located adjacent to each other, as illustrated in FIG. 11b, with the parent picker located to the left of the corresponding child picker. Grape type, or “varietal,” for example, can be a child variant to the parent variant “wine type.” Continuing the example, if the parent variant is wine type, and a user selects “red wine,” (as shown in FIG. 11a) and the child variant is grape type or, in industry parlance, “varietal,” the relevant child variant list may contain only red wine grapes. The shorter list can be referred to as a “dependency spectrum” (as illustrated in FIG. 11a), and can be defined in a data structure or in look-up tables.

In some embodiments, the interaction of the parent and child pickers is not symmetrical between the parent and child. If a user first interacts with a parent picker (as illustrated in FIG. 11b, state 2a), the child picker's list can be populated based on the parent picker selection. However, if the user first interacts with the child picker (as illustrated in FIG. 11b, state 2b), the parent picker can be automatically changed to the correct/appropriate picked variant, but no parent/child dependency is established, and thus, no repopulating of the child picker list occurs.

In some embodiments, if the user likes, he/she can interactively constrain the child picker to the parent picker by simply touching the parent picker. Additionally or alternatively, a button can be provided to trigger the child picker being constrained to the parent picker in some embodiments.

This constraining of picker choices can be cascaded across three or more pickers in some embodiments.

In some embodiments, a user can modify the selections in one or more of the pickers while not changing the selections in the remaining pickers. For example, after a user has selected red wines, Pinot Noir, California, and Russian River, the user may decide to change the second selection to Cabernet Sauvignon grape varietals while holding the other variants (selections) of the picker array as is. In order to do so, the user can spin the second picker wheel number so that Cabernet Sauvignon is selected instead of Pinot Noir. Depending on the picker variant selected, this may affect the other pickers based on the parent/child dependencies as described above.

In some embodiments, a new variant/option can be manually entered by a user into one or more of the pickers and the cascading of picker choices to/from this new variant can be based on a search query. For example, in a search application, a first picker wheel can be configured as an entry field, wherein a user can type in “architecture.” A search engine can then identify several related sub-categories, such as American, Schools, History, Commercial, residential, etc., for example. Child picker wheel choices can be generated based on these identified sub-categories. If the user then rotates a child picker wheel to pick Schools, a sub-child picker wheel can then be populated by more information from the search engine certain architecture school names (e.g., ordered of page rank or GoogleWord purchase).

In some embodiments, picker choices can be populated based on any suitable external data. For example, the picker choices can be updated based on products that are “in stock” at any given time. Or in the case of a special promotion, the top variant options may be determined by social networking traffic or trending and given special highlighting in the picker (e.g., the text is colored differently, etc.). An example would be a case wherein a merchandiser notifies all users that the ‘most-posted” wine in all Facebook® or Twitter® traffic will go on sale at 50% discount the following day. Users would have incentive to post positive notes about their favorite wine in hopes of having that wine discounted.

Once the user selects one or more variant(s), a dataset can be queried for relevant records, and other pickers can be populated based on parent/child mappings. The found records can then be presented in the gallery. This can be performed on a batched basis to give the user quick response while the entire balance of the found set is loaded in some embodiments.

In some embodiments, a ‘GO7’ button can be used so that the gallery and details are only updated when the GO button is pressed. This can halt all dataset query information until a user has completed selection of a desired combination of picker variants. In some embodiments, the “GO” button may not appear or may be disabled until the user begins to modify the pickers. This ‘GO” button functionality can serve to keep the interactive pickers fluid and real-time for tactile feedback, and can serve to reduce network traffic, which may reduce cost of operation for the user.

Turning back to FIGS. 2a and 2b, gallery B is now described in further detail. As can be seen in FIG. 2b, the gallery can include one or more visual data records that correspond to the picked variants in the picker array. These visual data records can be images, video, text, and/or any other suitable content for visually conveying information.

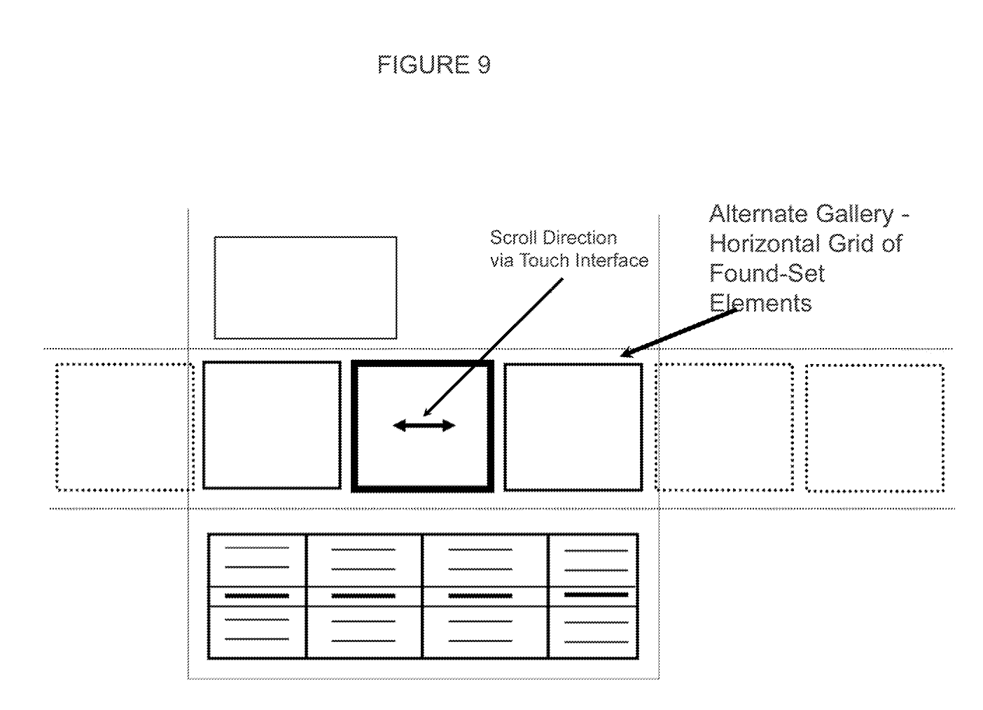

In some embodiments, the gallery can be presented in a “hierarchical” fashion—e.g., by the nature of the visual presentation, the records are presented in a particular order, such as an order of interest to the user. As shown, in some embodiments, the gallery can be presented as a carousel of images (and/or video) in an OpenFlow configuration—similar to the system found in the iTunes application from Apple Inc. As shown in FIG. 9, in some embodiments, this gallery can be presented as a simple scrollable list or grid of images (and/or video). Additionally or alternatively, in some embodiments, the gallery can be presented as other arrangements of images (and/or video) using DeepZoom from Microsoft Corporation, using Coollris from Coollris, Inc. and/or using any other suitable technique.

In some embodiments, the user can interact with the gallery images (or video). For example, using a touch screen interface, a user can swipe through multiple images in the gallery to find and select as desired image corresponding to a chosen record. For example, an image at the center of a carousel of images can be automatically selected upon a user swiping the carousel to position that image at the center or not taking any action to alter that image being positioned at the center.

In some embodiments, a user can elect to sort, filter, and/or perform any other suitable operation on the content in the gallery. For example, using the button Bs shown in FIG. 2a, a user can select to sort the content of the gallery. Any suitable criteria or criterion for sorting can be used, such as price, most popular, alphabetic by title, date of origin, etc. As another example, using the button Bf shown in FIG. 2a, a user can select to filter the content of the gallery. Any suitable criteria or criterion for sorting can be used, such as price range, style, availability (e.g., in-stock or not), numeric industry rating, etc. Controls for sorting, filtering, and/or perfuming any other suitable function can be located in any suitable location on the display, or omitted from the display in some embodiments.

In some embodiments, the images that are presented in the gallery can be selected based on any suitable external data, such as products that are “in stock” at any given time. Or in the case of a special promotion, product placement in the gallery order may be determined by social networking traffic or trending. An example would be a case wherein a merchandiser notifies all users that the “most-posted” wine in all Facebook or Twitter traffic will go on sale at 50% discount the following day. Users would have incentive to post positive notes about their favorite wine in hopes of having that wine discounted.

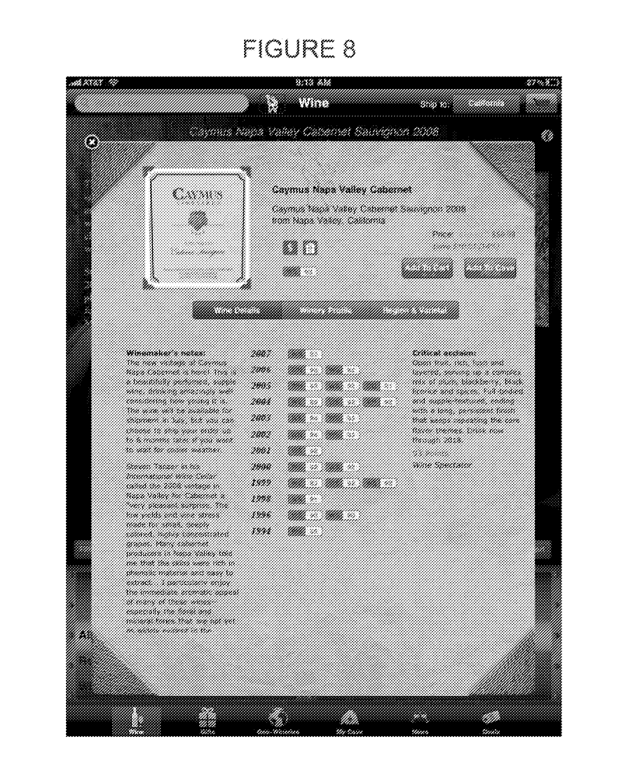

In some embodiments, upon selecting a desired image corresponding to a chosen record, further details of that record can be displayed in a section C1 or C2 as shown in FIG. 2a. Additionally or alternatively to displaying such details in a display integrated with the gallery and/or picker array, such details can be displayed in a pop-up display, a new screen, etc. (e.g., as shown in FIG. 8) in some embodiments.

In some embodiments, any suitable details relating to a chose record can be presented. For example, in some embodiments, such details can include detailed information relating to the selected image, such as a product's description, availability, cost(s), size(s), time(s), etc. As another example, in some embodiments, a map (C2 in FIG. 2a) can be presented showing a region corresponding to the chosen record (B in FIG. 2b). As a more particular example, in the case of displaying details related to a wine selection, a map showing a region corresponding to the winery from which the wine comes can be displayed. In some embodiments, such a map can be enhanced so that as a user changes the selected image in the gallery, the map is panned to move from one region corresponding to the previous chosen record to a second region corresponding to the next chose record. For example, as the user moves from one wine label to another in the gallery, the map shows a “flight” in slow motion from the first location to the second. So, if a user moves from a California Russian River Pinot Noir label to a France Bordeaux Cabernet label, the map can show a panning of the map from Northern California to Southwestern France.

In some embodiments, a user can select to modify the picked variants based on a selected image in the gallery. For example, in the wine shopping example, a user might set his/her picker array to Cabernet Sauvignon and all other variants left not selected (e-g., using an “all” option on the other pickets). In response to this, the gallery may display a wide variety of Cabernet Sauvignon wine options from around the world. The user may then manipulate the gallery to pick a Cabernet Sauvignon from the Bordeaux Region of France. At that point, the user might notice in the product detail information that Bordeaux is well known for their Cabernet's and then touch a button that automatically adjusts their “‘Appellation” picker to Bordeaux to correspond to the characteristics of the selected image in the gallery. This new picker selection can then update the picker choices on any child pickers and update the gallery so that the user only sees Cabernet Sauvignon wines from the Bordeaux region of France.

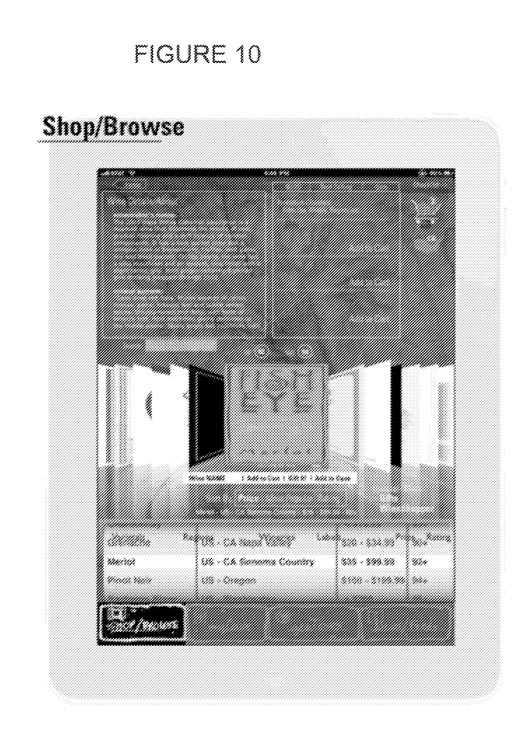

In some embodiments, once a user selects an image from a gallery, the user can elect to take some action related to the image. For example, in some embodiments, the user can elect to view additional information, add an item corresponding to the image to a shopping cart (see FIG. 10), purchase the item corresponding to the image, add an item to a favorites list, create a bookmark for the item, etc.

FIGS. 6 and 7 illustrate how the user interface can be implemented in “Landscape” mode, as well as with alternative background or aesthetic presentations, as in the case of the wine shopping “Gifts” layout. As illustrated in the gifts merchandising implementation shown in FIG. 7, a background image can convey the spirit of festivities without detracting from the usability features and functionality of the interface.

In some embodiments, systems, methods, and media as described here can be implemented in software running on a suitable hardware platform. The software may be written in any suitable language, such the XCode Integrated Development Environment (IDE), using Cocoa frameworks (Libraries, APIs, and runtimes) for Objective-C Language, as implemented by Apple Inc. for their mobile devices and iOS (iPhone and iPad), and may operate on any suitable operating system.

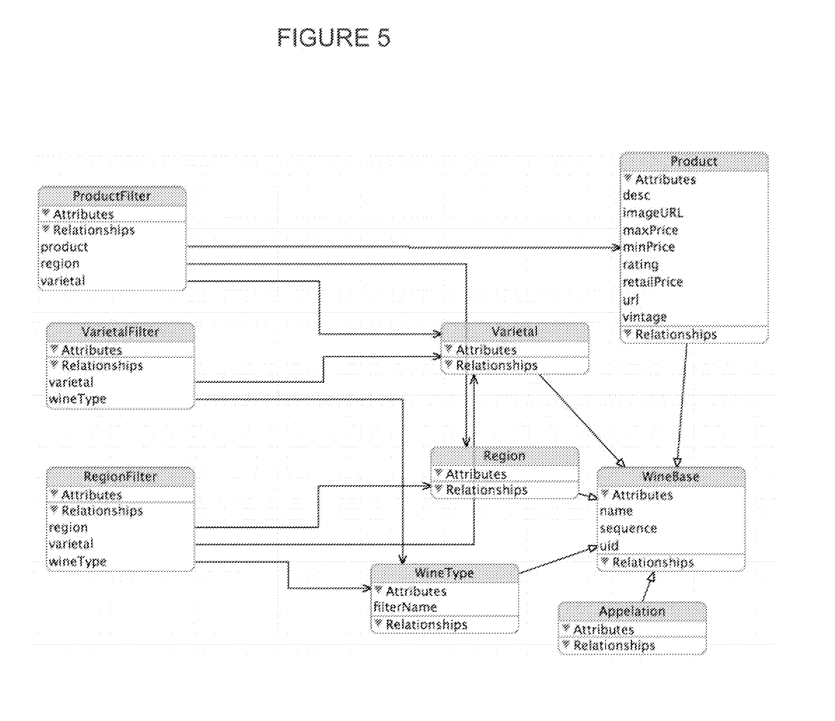

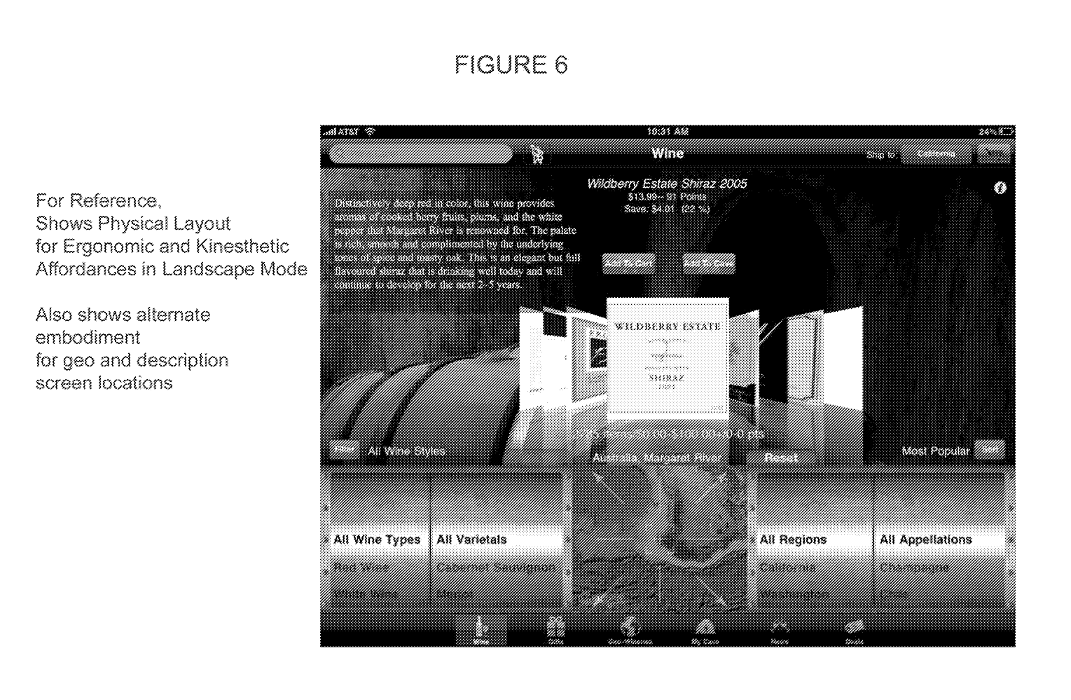

In some embodiments, data can be stored in a structured data repository, or database/dataset as illustrated in FIGS. 4 and 5. Such a data repository, or database/dataset, can reside on a hardware device, on a local area network accessible from the device, on the Internet while accessible to the device, and/or at any suitable location.

In some embodiments, a master data structure can be implemented as a web-based, server hosted SEQueL (Structured English Query Language) database of type “SQL Server” from Microsoft Corporation. The SQL Server can be implemented with an application programming interface (API) for defining and managing data request transactions.

In some embodiments, software used to implement the mechanisms described herein can be implemented in a “Model-View-Controller” framework that manages the tactile/visual Graphical User Interface (GUI) interface elements as well as the query and API transactions between the device and the structured dataset on a server.

In some embodiments, an API for accessing data can contain a definition wherein record fields and valid query parameters are structured, maintained, and refined. The structured dataset can contain the basic relational constructs of the data, as exemplified in FIG. 5.

In some embodiments, within an API definition, queries from the software application can draw data from the database (including, but not limited to, product name, price, savings, year of origin, winery of origin, critical acclaim, picture of the bottle label, picture of the winery, geo latitude/longitude of the source winery, ratings, type, style, etc.), and then display them for the user in a synchronized fashion.

In some embodiments, picker information can be located in “quasi-fixed,” or “static” look-up tables (LUTs) on a user device. These LUTs can provide information for cross-populating pickers as users input their requests. For example, a LUT can store that if a user requests “red wines,” there is a specific list of wine grape types (“‘varietals”) that fit that picked variant.

The advantage of static local LUTs is a faster application user experience, and reduced wireless or telecommunications data volume cost for the user. In the case of a fast network and/or fast devices, these LUTs can be replaced by more dynamic data present in the remote dataset and served up via the API.

In addition to picker LUTs, dataset information can be cached on a user device.

Any of the data and/or information transferred between a user device and one or more remove data storage devices (e.g., such as a server) can be compressed in order to speed data delivery, encrypted to protect the data, etc.

The mechanisms described herein can be implemented on any suitable hardware. For example, the mechanisms described herein can be implemented on one or more mobile phones, computers, appliances, servers, databases, etc. These hardware devices can be any of a general purpose device such as a computer or a special purpose device such as a client, a server, etc.

Any of these general or special purpose devices can include any suitable components such as a hardware processor (which can be a microprocessor, digital signal processor, a controller, etc.), memory, communication interfaces, display controllers, input devices, etc.

In some embodiments, any suitable computer readable media can be used for storing instructions for performing the processes described herein. For example, in some embodiments, computer readable media can be transitory or non-transitory. For example, non-transitory computer readable media can include media such as magnetic media (such as hard disks, floppy disks, etc.), optical media (such as compact discs, digital video discs, Blu-ray discs, etc.), semiconductor media (such as flash memory, electrically programmable read only memory (EPROM), electrically erasable programmable read only memory (EEPROM), etc.), any suitable media that is not fleeting or devoid of any semblance of permanence during transmission, and/or any suitable tangible media. As another example, transitory computer readable media can include signals on networks, in wires, conductors, optical fibers, circuits, any suitable media that is fleeting and devoid of any semblance of permanence during transmission, and/or any suitable intangible media.

This description will address the specific application of the invention wherein the computer platform in use is a multi-touch, mobile device such as the Apple iPad, the iPhone (both running Apple iOS operating system software), or the HTC “Flyer” tablet, which runs Android operating system software.

In another preferred embodiment of the invention, an interface is created which results a user having access to multiple “modalities” of media, all within a single application interface framework. The interface consists of the following: a “franchise” application, a themed background, a tiered scrolling gallery, and media content modules. The franchise application framework of the current invention allows a user to experience all of these elements within an organized, structured interface.

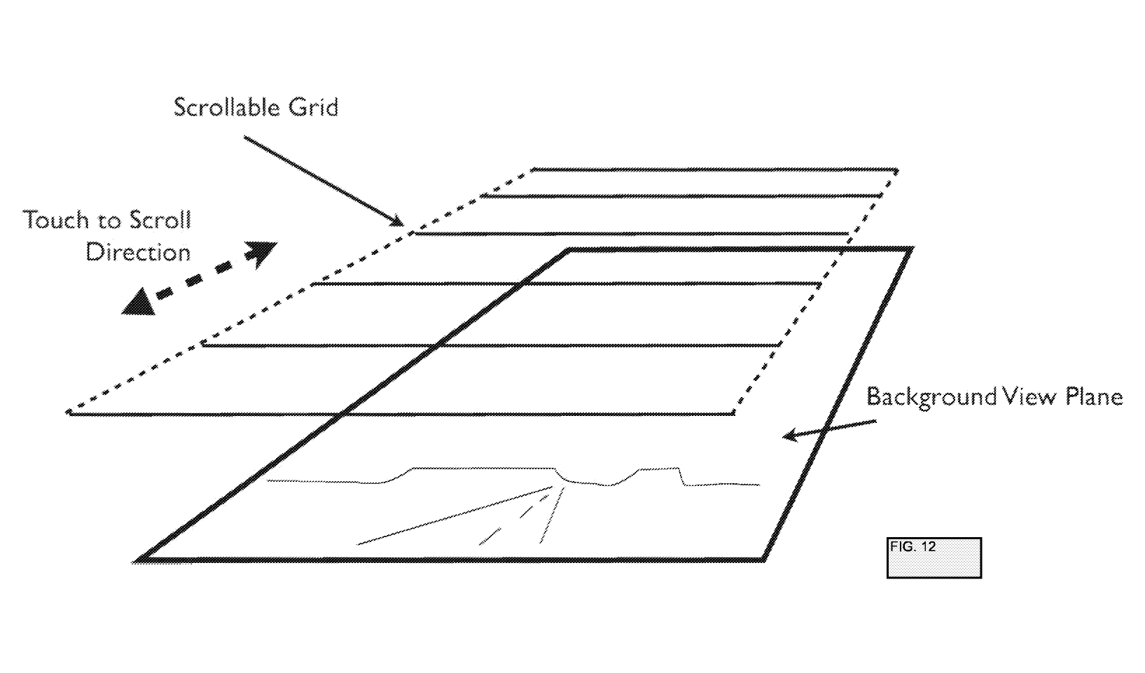

In FIG. 12, the background plane of the application is illustrated to indicate that it resides visually “behind” the tiered scrolling gallery. The background is used to establish and reinforce the franchise artistic and visual theme. This background may include subtle animation, or animated “sprite” elements, which give a dynamic visual appearance to the theme. Additionally, the background may include the presence of a themed musical or sonic soundtrack that starts upon opening the application. In the case of Gone with the Wind, one can imagine the soundtrack of that film beginning upon opening the app.

The background is generally a static element, overall, because it is intended to give a frame of reference to the tiered scrolling gallery, which is virtually layered on top of the background.

The tiered scrolling gallery is organized a software “view” which serves as a metaphorical bookshelf, upon which icons of media modules can reside. This gallery is moved up and down (in the same plane as the background) via the touch interface, or, in the case of a desktop or laptop browser, it is moved with a mouse. The gallery “grid” is substantially transparent, giving the user the ability to always see the theme background, while navigating the modules and making a selection.

Importantly, the invention incorporates the concept of allowing each horizontal “shelf’ to be scrolled side to side. This is because each shelf will come to be associated with a particular form of media—for example, the “film” shelf, or the “video” shelf, or the “book” shelf, or the “game/interactive” shelf.

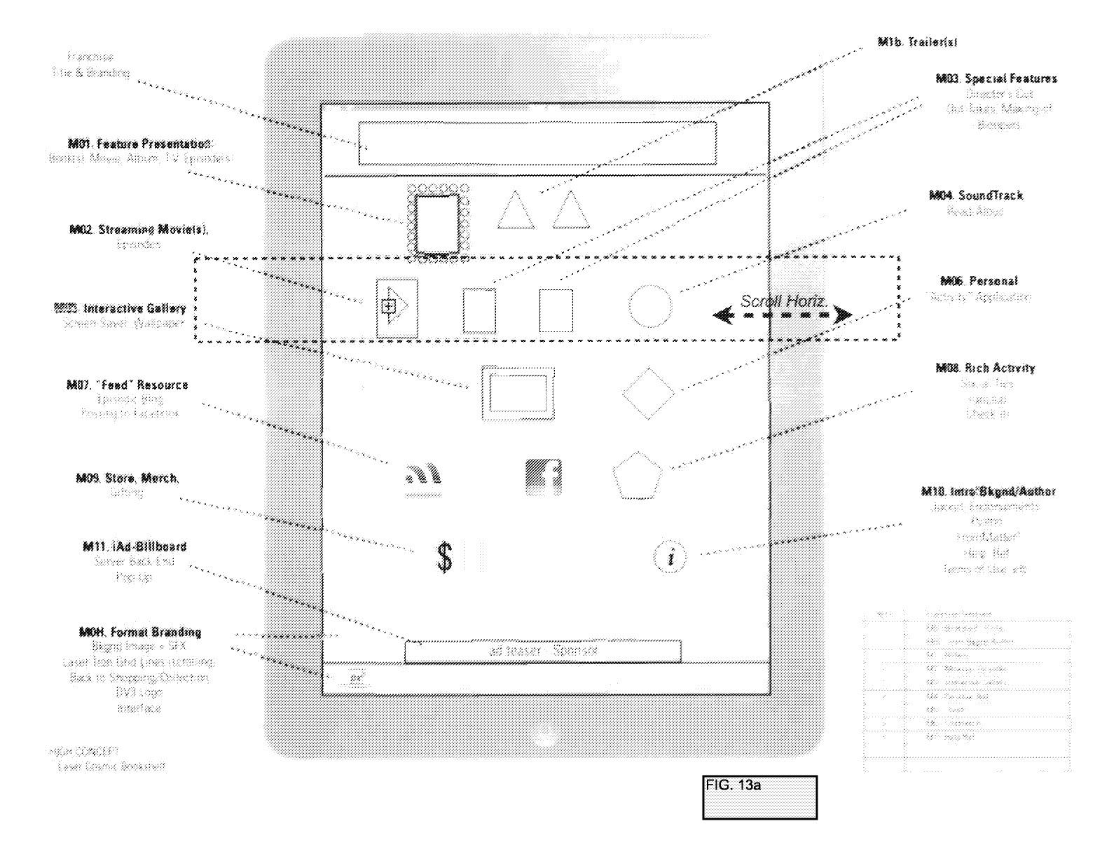

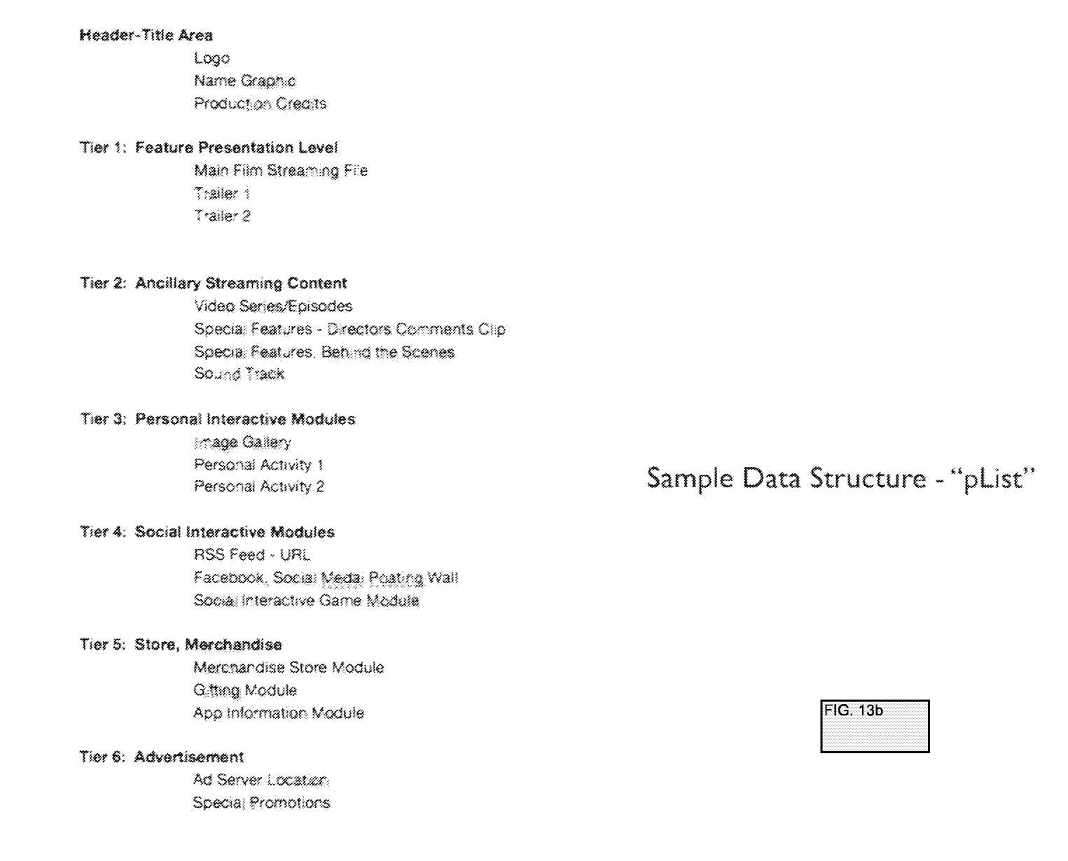

This shelf concept is explained in detail in FIG. 13a, which serves as the core of the Content Franchise Application Format of the invention. The format is organized as follows.

First, is the basic franchise title and branding, identified at the top of the figure. This may include the name, logo, visual branding, or identity of the franchise. To clarify, all the elements indicated in this figure reside graphically on the tiered scrolling gallery level of the multi-plane visual interface.

The first shelf of the interface is currently chosen to be the “Feature Presentation.” Thusly, in the case of a franchise that is predominantly presented as a film, it would be film, and all media related to a film release, including trailers and promotional clips. If the primary format is television or video, the Feature Presentation shelf would showcase that type of content.

It is anticipated that the playing of a digital film or video file would use the resident or “native” media player utility application on the given platform of the device. In the case of iOS, this may be QuickTime® media player, or a flash player, or a streaming technology such as youTube®.

The second shelf provides a secondary tier for content that may involve video. Importantly, this tier is illustrated to indicate that each shelf may scroll side-to-side in order to populate the shelf with multiple items. The user knows that this shelf has a specific media type, so they build an intuitive sense for what they will find in that level.

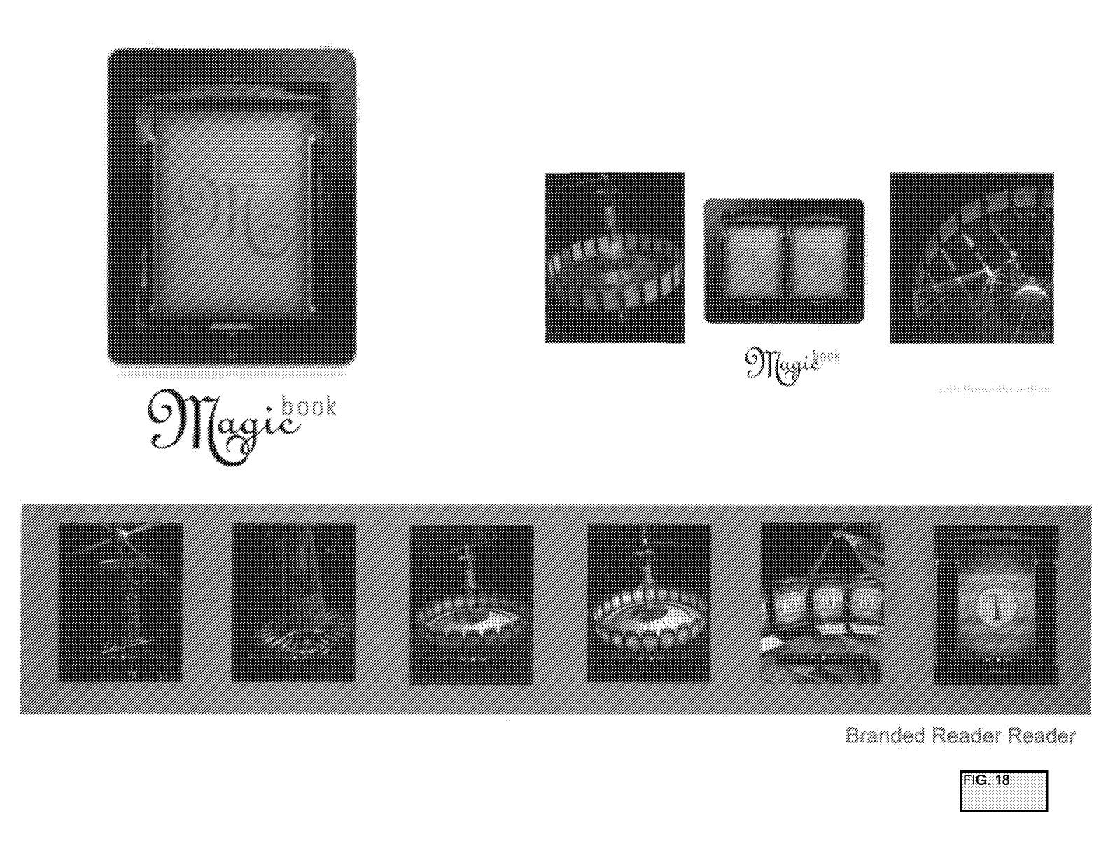

An important element of the invention is the creation of a “reader” module, which allows the user to experience an electronic book in a way that emulates the sensory experience of a book. A module that offers a book experience could exist on the Feature Presentation tier of the format, or it could be on the secondary shelf. When touched or selected, it launches the reader, FIG. 18, which, in the case of the current invention, is visually themed to be like a classical musical instrument.

The third shelf provides an organizational tier for personal interactive modules, which might include a gallery of images, a personal themed journal, or a simple single-user game. The fourth shelf is intended to showcase social or multi-player activities within the franchise theme. This will be an important category of media that includes content such as RSS feeds, blogs, social media postings, and original games and activities.

The fifth tier of the interface is intended to host commercial interfaces, such as merchandise shopping, and background information on the app. The former may include direct shopping of related merchandise, or the “gifting” of the app to other people. This shopping tier may also offer the service of purchasing or renting or subscribing to certain additional modules for the app. In the current embodiment of the invention, a user may first get the application for free and then decide to purchase one or more modules. In this case, the free app may contain the actual trailers for a movie, so that the user can decide if they want to purchase the product or rent it. The background information may contain terms of use, privacy policy, or other technical support information for the use and maintenance of the app.

Near the bottom of the template is an area dedicated to advertisements, which may be static, or may be “served” on a dynamic basis, based on time of day, user demographic, or preferences. This area might also be used for the promotion of related content modules that may be up-coming or new to the franchise app.

Finally, at the bottom of the template may optionally reside an array of buttons to directly access specific areas of the application.

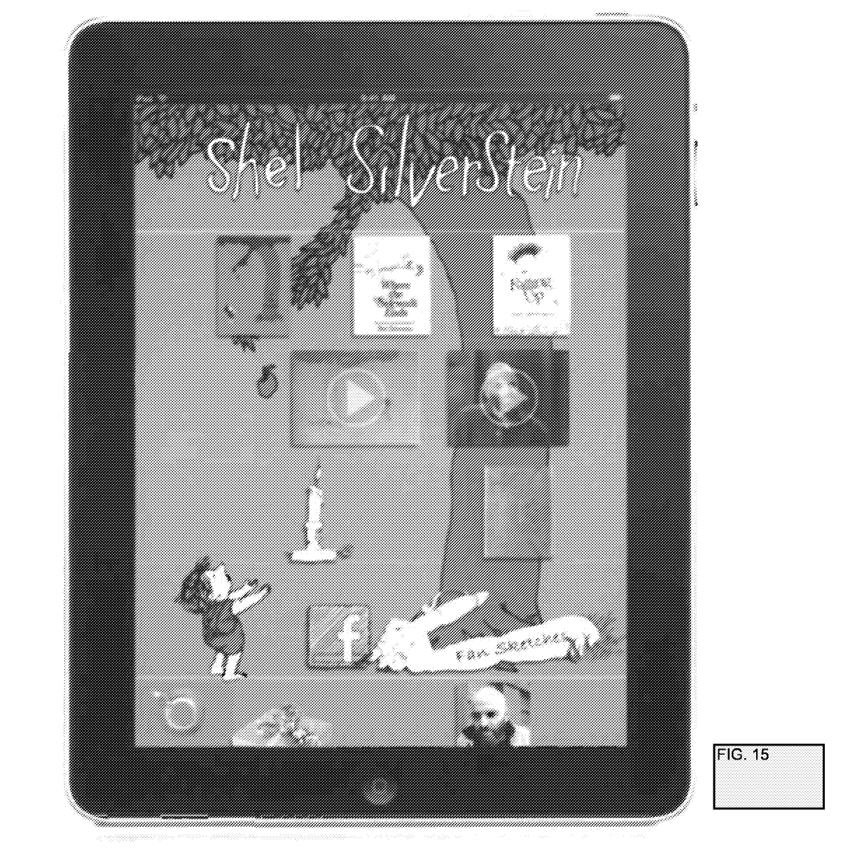

As examples of this format invention in action, we are providing a screenshot of an app (FIG. 15) that would represent an author who has written books, appeared in television shows, and is known for his interesting hand sketches. In this app, the tree leaves occasionally fall to the ground, and the apple drops every few minutes.

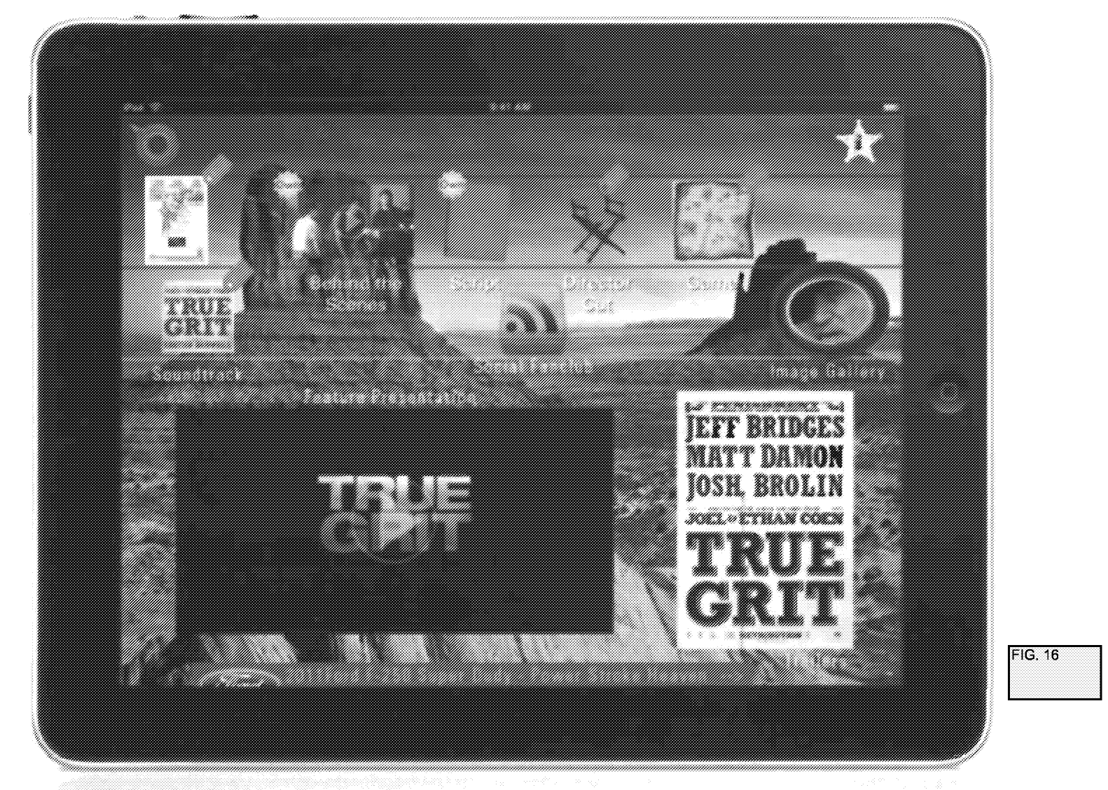

In the case of a western movie, (FIG. 16), the interface is shown in “landscape” format, where the mobile device may be held in a horizontal orientation. In this case, the tiered scrolling gallery becomes wider and shifts to the new layout.

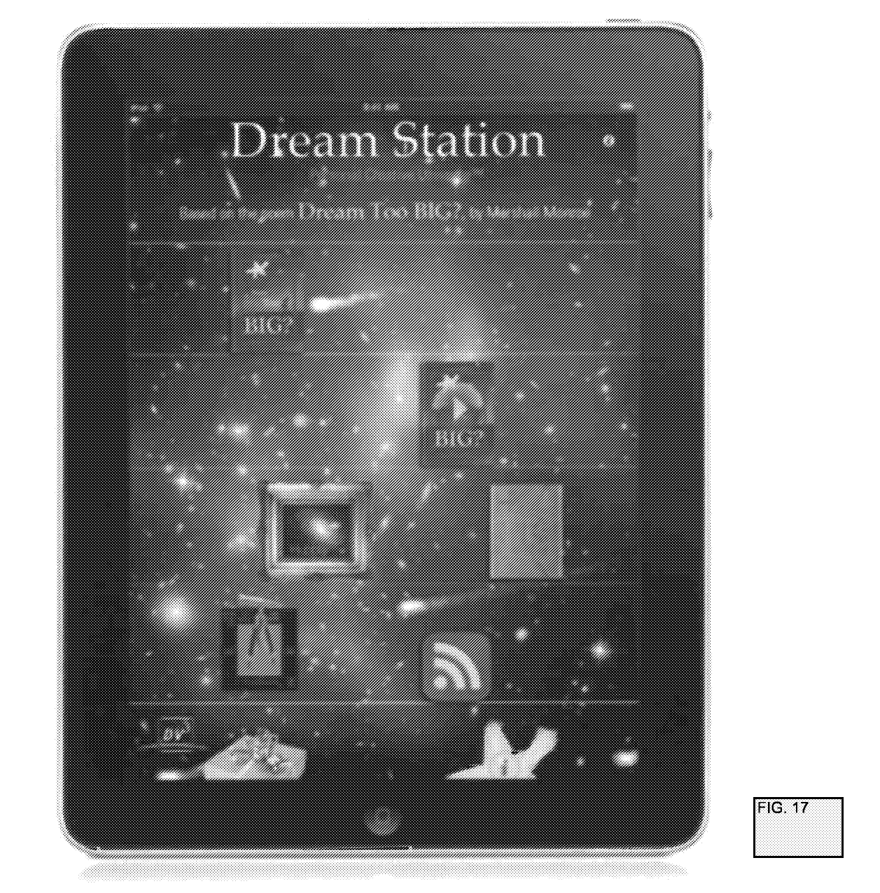

In the case of a franchise based on a piece of illustrated poetry (FIG. 17), one sees the background image having a view of outer space, with animated comets flying by occasionally, with a sound track of symphonic music.

This interface invention, which is optimized to strike the optimal balance between structured “familiarity” across franchises for the user and open-ended creative opportunity in the development of modules, requires a structured data architecture. This data structure (see FIG. 13b Example), often implemented in the form of a “pList,” or “parameter list,” will include the names of each specific module in each “class” of media module, and will contain meta information specific to the app itself. The meta information may include origin, theme topic descriptors, and logical search criteria. The pList record may also include pointer information, in the name of a file path or URL, which identifies the location of the actual media file which will be played when the module is selected. This approach allows for the distributed storing and “sourcing” of actual files from multiple locations. It may be that these files are archived in different locations for business or technical reasons. This also establishes the infrastructure for certain content modules to be sold or “syndicated” from various sources.

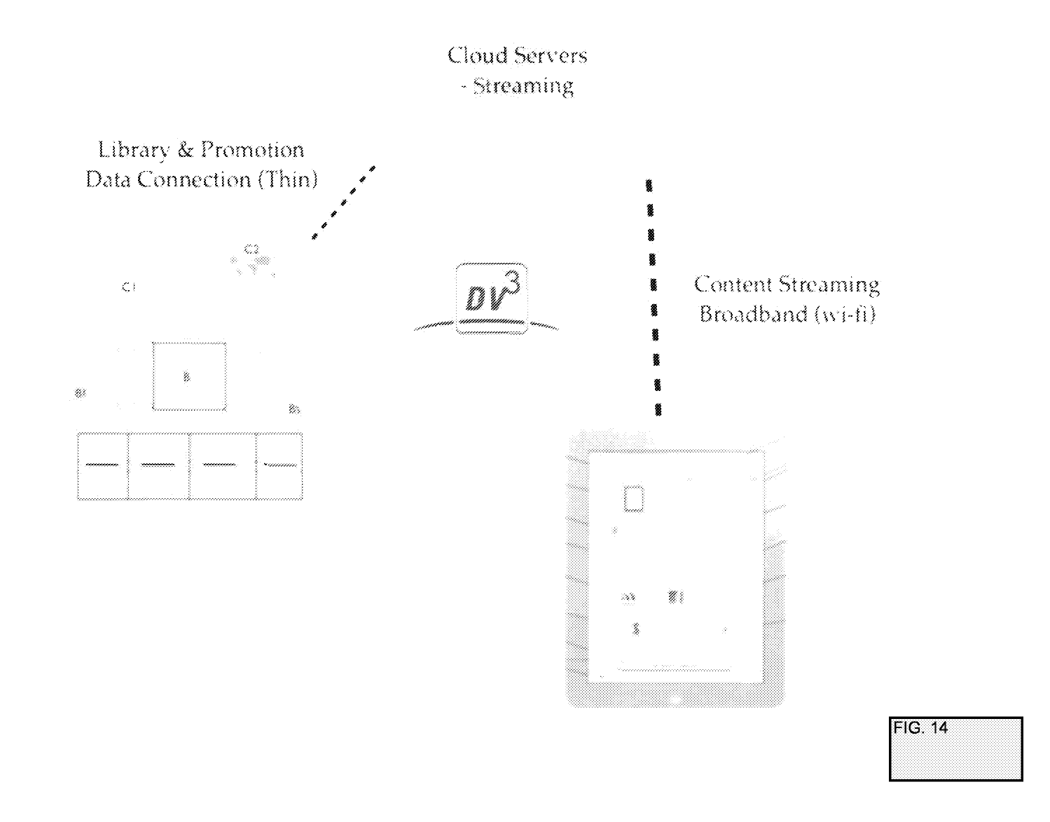

In terms of a technical data architecture for the system, FIG. 14, the content for the application will reside in a client-server type architecture, where the majority of content will reside in remote, network-accessible hosting environments. As needed, the software architecture will provide for the caching of some data local to the device, such that a plurality of franchise applications can be used in “stand-alone” mode. This is useful in the event that the user will be away from a high-bandwidth network or internet connection for a period of time, for example on an airplane flight, and they want to be able to access the content.

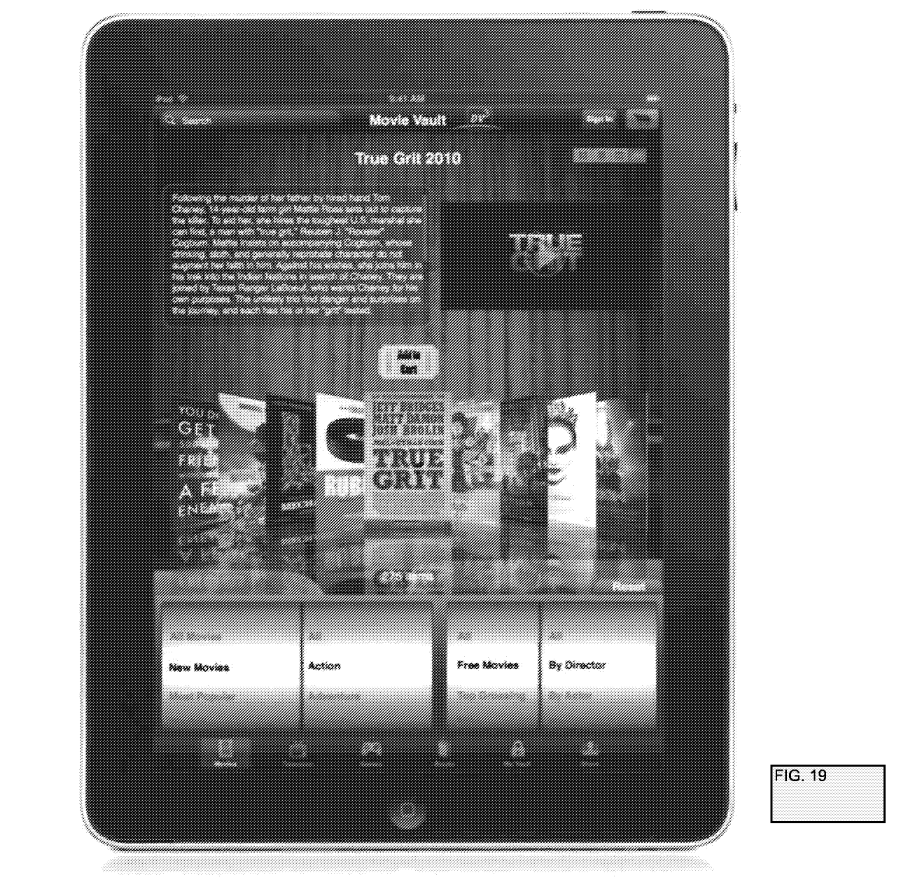

One important, but optional element of the invention is the use of a collection management application program for finding, discovering, purchasing, and collecting the franchise applications. The preferred embodiment of this shopping application consists of a navigation scheme of pickers, associated with an interactive gallery of icons (FIG. 14, Shopping and Promotion Interface). While the present invention provides a specific design for this interface (FIG. 19), many embodiments are possible, as detailed above. This collection management system should allow for the preview of application graphics and meta information.

While the current embodiment of the invention is described for the Apple devices iPad and iPhone, this franchise template is envisioned as working substantially the same on other mobile devices, and even on a desktop or laptop computer. Also, it is important to note that there may be variations where the content form tiers are in different orders, but the key is that the form tiers aggregate content modules in a substantially form-related way. Additionally, the graphic layout of the tiered scrolling gallery may be modified to take other designs.

In the preferred embodiment, and as readily understood by one of ordinary skill in the art, the apparatus according to the invention will include a general or specific purpose computer or distributed system programmed with computer software implementing the steps described above, which computer software may be in any appropriate computer language, including C++, FORTRAN, BASIC, Java, assembly language, microcode, distributed programming languages, etc. The apparatus may also include a plurality of such computers/distributed systems (e.g., connected over the Internet and/or one or more intranets) in a variety of hardware implementations. For example, data processing can be performed by an appropriately programmed microprocessor, computing cloud, Application Specific Integrated Circuit (ASIC), Field Programmable Gate Array (FPGA), or the like, in conjunction with appropriate memory, network, and bus elements.

Note that in the specification and claims, “about” or “approximately” means within twenty percent (20%) of the numerical amount cited. All computer software disclosed herein may be embodied on any non-transitory computer-readable medium (including combinations of mediums), including without limitation CD-ROMs, DVD-ROMs, hard drives (local or network storage device), USB keys, other removable drives, ROM, and firmware.

Although the invention has been described in detail with particular reference to these preferred embodiments, other embodiments can achieve the same results. Variations and modifications of the present invention will be obvious to those skilled in the art and it is intended to cover in the appended claims all such modifications and equivalents. The entire disclosures of all references, applications, patents, and publications cited above are hereby incorporated by reference.

What is claimed is:

1. A method of displaying information on a display, the method comprising the steps of:
displaying a cascading variant picker array; and
simultaneously displaying a gallery of images associated with the information content of the array.

2. The method of claim 1 wherein a parent-child relationship exists for the elements of the array when moving left to right.

3. The method of claim 1 wherein the gallery is an element within a vertically scrollable grid of horizontal elements.

4. The method of claim 3 wherein two or more of the elements are scrollable horizontally.

5. The method of claim 1 wherein the array presents categories of items for purchase and the gallery presents images of items found in the corresponding categories, which items can be purchased via the corresponding images.

6. The method of claim 1 wherein the array displaying step comprises displaying a cascading variant picker array proximate a bottom of a display.

7. The method of claim 1 additionally comprising the step of populating the picker with keywords chosen based on search results.

8. The method of claim 1 wherein the gallery is selected from the group consisting of a grid gallery, a coverflow gallery, a deep zoom gallery, and a list gallery.

9. A method of displaying information on a display, the method comprising the steps of:
displaying a background; and
simultaneously superimposed on the background displaying a vertically scrollable arrangement.

10. The method of claim 9 wherein the arrangement displaying step comprises displaying a vertically scrollable grid of horizontal elements.

11. The method of claim 10 wherein in the arrangement displaying step two or more of the elements are scrollable horizontally.

12. The method of claim 10 wherein one of the elements comprises a cascading variant picker array.

13. The method of claim 12 wherein a parent-child relationship exists for the elements of the array when moving left to right.

14. The method of claim 12 wherein one of the elements comprises a gallery of images associated with the information content of the array.

15. The method of claim 9 wherein all elements of the vertically scrollable arrangement relate to a common topic.

16. The method of claim 15 wherein each element relates to a distinct common media format relating to the common topic.

17. The method of claim 16 wherein each element displays items not owned by the user differently from items owned by the user.

18. A non-transitory storage medium comprising computer software for displaying information on a display, said software comprising:
code displaying a cascading variant picker array; and
code simultaneously displaying a gallery of images associated with the information content of the array.

19. The medium of claim 18 wherein a parent-child relationship exists for the elements of the array when moving left to right.

20. The medium of claim 18 wherein the gallery is an element within a vertically scrollable grid of horizontal elements.

21. The medium of claim 20 wherein two or more of the elements are scrollable horizontally.

22. The medium of claim 18 wherein the array presents categories of items for purchase and the gallery presents images of items found in the corresponding categories, which items can be purchased via the corresponding images.

23. The medium of claim 18 wherein the array displaying code comprises code displaying a cascading variant picker array proximate a bottom of a display.

24. The medium of claim 23 additionally comprising code populating the picker with keywords chosen based on search results.

25. The medium of claim 18 wherein the gallery is selected from the group consisting of a grid gallery, a coverflow gallery, a deep zoom gallery, and a list gallery.

26. A non-transitory storage medium comprising computer software for displaying information on a display, said software comprising:
code displaying a background; and
code simultaneously superimposed on the background displaying a vertically scrollable arrangement.

27. The medium of claim 26 wherein the arrangement displaying code comprises code displaying a vertically scrollable grid of horizontal elements.

28. The medium of claim 27 wherein in the arrangement displaying code two or more of the elements are scrollable horizontally.

29. The medium of claim 27 wherein one of the elements comprises a cascading variant picker array.

30. The medium of claim 29 wherein a parent-child relationship exists for the elements of the array when moving left to right.

31. The medium of claim 29 wherein one of the elements comprises a gallery of images associated with the information content of the array.

32. The medium of claim 27 wherein all elements of the vertically scrollable arrangement relate to a common topic.

33. The medium of claim 32 wherein each element relates to a distinct common media format relating to the common topic.

34. The medium of claim 33 wherein each element displays items not owned by the user differently from items owned by the user.
